(19) United States
(12) Patent Application Publication
(10) Pub. No.: US 2011/0312334 A1
(43) Pub. Date: Dec. 22, 2011

(54) SATELLITE POSITIONING DEVICE AND ACQUISITION METHOD

(75) Inventor: Kiyoshi Yajima, Saitama (JP)

(73) Assignee: Pioneer Corporation, Tokyo (JP)

(21) Appl. No.: 12/673,001

(22) PCT Filed: Aug. 6, 2007
(86) PCT No.: PCT/JP2007/065357

§ 371 Date: Feb. 10, 2010

(51) Int. Cl. H04W 24/00

(52) U.S. Cl. 455/456.1

(57) ABSTRACT

A signal generating unit generates a signal in which the satellite signal from each satellite is squared. A time-frequency transforming unit performs time-frequency transformation on the signal thus generated. An acquisition unit identifies an outstanding type of frequency in the frequency characteristics acquired by the time-frequency transformation and acquires each of the satellite signals on the basis of the identified usual frequency in the frequency characteristics. This allows the acquisition unit to hit the vital spot of the frequency at which each of the satellite signals is likely to exist.

### CROSS-REFERENCE TO RELATED APPLICATION

This is an application PCT/JP2007/65357, filed Aug. 6, 2007, which was not published under PCT article 21(2) in English.

### BACKGROUND OF THE INVENTION

1. Field of the Invention

The present invention relates to a satellite positioning device and acquisition method for determining a position using an acquired satellite signal.

2. Description of the Related Art

A GPS (Global Positioning System) is one example of a satellite positioning system of a prior art. A GPS receiver, which is a part of such a satellite positioning system, receives a signal related to positioning information transmitted from a satellite, performs demodulation, and calculates a position based on the resulting acquired data.

Some GPS receivers are provided with a so-called temperature compensated crystal oscillator (hereinafter “TCXO”). This TCXO comprises storage means (hereinafter “memory”), which stores temperature compensation data.

In the GPS receiver of the prior art, the memory of this TCXO further stores the center oscillation frequency of the TCXO, the offset value of the oscillation frequency at a reference temperature, and the maximum frequency change rate of the TCXO when the temperature is changed at 1° C./second (refer to JP, A, 2006-170673). With such a configuration, the GPS receiver of the prior art performs control when operation is first started, setting the center frequency of TCXO and the offset value of the oscillation frequency at the reference temperature in a fractional synthesizer of a primary demodulating unit to ensure that the output frequency of the fractional synthesizer becomes a predetermined center frequency of the received intermediate frequency signal. This makes it possible for the GPS receiver of the prior art to more quickly acquire satellite signals from satellites that have deviated from the center frequency due to a Doppler shift.

### SUMMARY OF THE INVENTION

Nevertheless, such a GPS receiver of the prior art only estimates the “TCXO shift” at the reference temperature and sets the offset value of the oscillation frequency at the reference temperature and the maximum frequency change rate of TCXO when the temperature is changed at 1° C./second based on empirical rules. Under such circumstances, it is unclear at the present moment to what extent the target frequency to be acquired has been accurately identified, and it cannot be said that the frequency of the satellite signal from each satellite has been accurately identified.

The above-described problem is given as one example of the problems that are to be solved by the present invention.

### Means for Solving the Problem

To overcome the problem mentioned above, the invention according to claim 1 provides a satellite positioning device comprising: a signal generating unit configured to generate a signal in which a satellite signal from each satellite is squared; a time-frequency transforming unit configured to execute time-frequency transformation on the signal generated by the signal generating unit; and an acquisition unit configured to identify a frequency of an outstanding type in frequency characteristics acquired by time-frequency transformation by the time-frequency transforming unit, and acquire each of the satellite signal based on the identified frequency; a temperature compensated crystal oscillator configured to generate a reference clock while performing temperature compensation when a satellite signal from each of the satellites is converted to an intermediate frequency; a storage unit configured to store orbital information of each of the satellites; and a matching unit configured to identify a frequency deviation of the temperature compensated crystal oscillator by means of matching the frequency indicating the outstanding type in the frequency characteristics with an estimated frequency of each of the satellite signals based on the orbital information..

### BRIEF DESCRIPTION OF THE DRAWINGS

FIG. 1 is a block diagram illustrating a configuration example of the satellite positioning device of the embodiment.

FIG. 2 is a block view illustrating an example of the software that runs on the DSP shown in FIG. 1.

FIG. 3 is an image view of a field of frequency bins for the acquisition process.

FIG. 4 is a flowchart illustrating an example of the procedure of the reception positioning process.

FIG. 5 is a flowchart illustrating an example of the procedure of the acquisition process shown in FIG. 4.

FIG. 6 is a diagram illustrating an example of the peaks appearing at the frequencies corresponding to each satellite signal in the frequency characteristics acquired by the acquisition process shown in FIG. 5.

FIG. 7 is a diagram illustrating an example of the position in the sky of each satellite at a certain time as acquired from almanac data (orbital information).

FIG. 8 is a diagram illustrating an example of frequency characteristics at that specific time.

### DETAILED DESCRIPTION OF THE PREFERRED EMBODIMENTS

The following describes an embodiment of the present invention with reference to accompanying drawings.

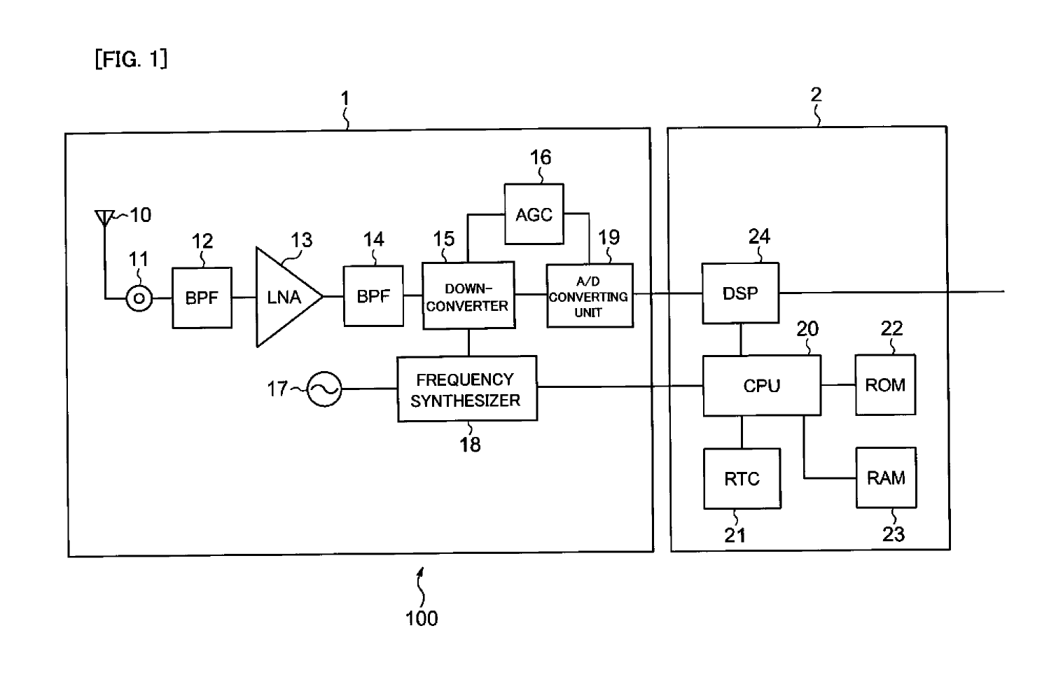

FIG. 1 is a block diagram illustrating a configuration example of a satellite positioning device 100, which serves as an example of a satellite positioning device of this embodiment. The satellite positioning device 100 acquires and tracks a plurality of satellites, and performs two-dimension or three-dimensional positioning calculations in accordance with the number of satellites acquired and tracked. This satellite positioning device 100 comprises an RF (Radio Frequency) unit 1 configured to downconvert received satellite signals, and a digital processing unit 2 configured to execute tracking and positioning from the acquisition of satellite signals. Note that a satellite number is associated with each satellite.

The RF unit 1 comprises a GPS antenna 10, an RF input unit 11, BPFs (Band Pass Filters) 12 and 14, an LNA (Low Noise Amplifier) 13, a downconverter 15, an AGC (Auto Gain Control) 16, a TCXO (Temperature Compensated crystal Oscillator) 17, a frequency synthesizer 18, and an A/D converting unit 19.

The GPS antenna 10 has the function of receiving satellite signals transmitted from satellites. The BPF 12 receives the satellite signals received by the GPS antenna 10 via the RF input unit 11. The BPS 12 is an electronic filter that allows only those satellite signals having a predetermined bandwidth to pass.

The LNA 13 is a low noise amplifier, and the BPS 14 attenuates the noise that is outside the GPS bandwidth from the frequency bandwidth of the satellite signals inputted via the LNA 13, and outputs the attenuated noise to the downconverter 15.

The TCXO 17 is a local oscillator that oscillates frequencies lower than the frequency of the received signals inputted to the downconverter 15. The frequency synthesizer 18 generates a local oscillator signal based on the output from the TCXO 17, and outputs the generated signal to the downconverter 15.

The downconverter 15 uses the local oscillator signal from the frequency synthesizer 18 to convert the RF signal (the received signal) to an intermediate frequency, that is an IF (Intermediate Frequency) signal, having improved stability behavior and selection characteristics according to the control performed by the AGC 16, and outputs the IF signal to the A/D converting unit 19. This A/D converting unit 19 samples the IF signal thus converted, converts the IF signal, which is an analog signal, to a digital signal, and outputs the converted signal to the digital processing unit 2.

Note that the above-described TCXO 17 is used for calculating the pseudo range between the satellite and GPS antenna 10. The TCXO 17, unlike an atomic clock mounted on a satellite, includes errors. The “error of the built-in clock of the satellite positioning device” refers to the error of the TCXO 17.

The digital processing unit 2 comprises a CPU 20, an RTC (Real-Time Clock) 21, a ROM 22, a RAM 23, and a DSP (Digital Signal Processor) 24.

The CPU 20 operates based on the clock outputted from the frequency synthesizer 18, and controls the digital processing unit 2, in its entirety. The RTC 21 is a clock IC (Integrated Circuit) that operates by a crystal oscillator (not shown), and functions as a clock reference when the power supply is turned on, for example, before the TCXO starts operation.

The ROM 22 stores various data, including programs for performing positioning calculations, for example. The RAM 23 temporarily stores data that are to be processed at high-speed, for example. The DSP 24 performs positioning calculations based on the IF signal from the RF unit 1.

Here, the satellite positioning device 100 attempts to simultaneously acquire and track a plurality of satellites (preferably four or more) to perform positioning calculations with higher accuracy. The above-described DSP 24 comprises a plurality of system channels respectively corresponding to the plurality of satellites, and processes the IF signal using the individual channels. In each channel, the Doppler of the IF signal is removed to the extent possible so that code correlation detection and integration processing by at least one correlator are executed. The DSP 24 performs positioning calculations using the processing signals from each channel.

The signals subjected to positioning calculation are outputted to a CPU 20 as position measurement results and velocity measurement results. The position measurement results are calculated based on the pseudo range between each of the plurality of satellites and the GPS antenna 10.

Note that each channel acquires a satellite by detecting the correlation peak of the IF signal and carrier (carrier wave) diffused by the reference code of the PRN (Pseudo Random Noise) code. Furthermore, each channel corrects the tracking error of the code and carrier of the satellite signals of the acquired satellite, and continues tracking the satellite. The satellite is thus acquired and tracked, and the information is used for positioning.

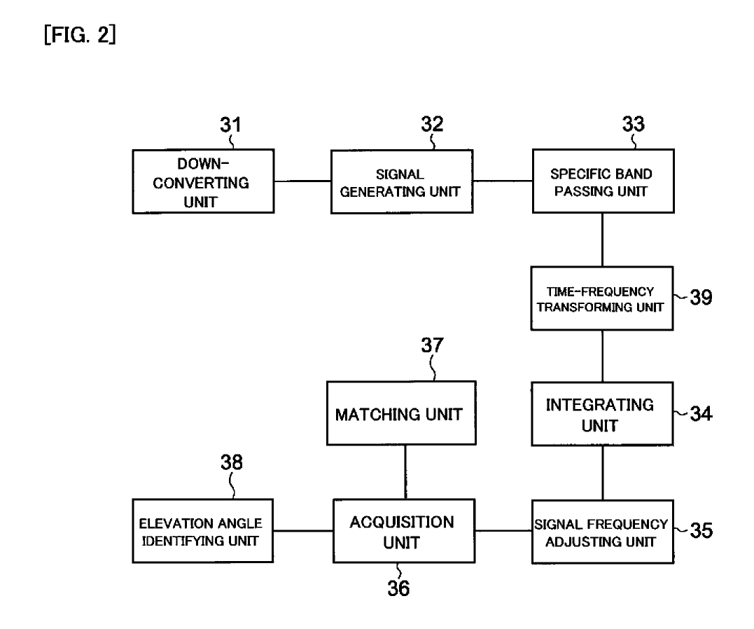

FIG. 2 is a block view illustrating an example of the software that runs on the DSP 24 shown in FIG. 1. That is, FIG. 2 illustrates a configuration example of the program that runs on the DSP 24 under the control of the CPU 20.

A signal generator unit 32, a time-frequency transforming unit 39, and an acquisition unit 36 run on the DSP 24. A matching unit 37 and an elevation angle identifying unit 38 may also run on the DSP 24. In addition, a down-converting unit 31, a specific band passing unit 33, an integrating unit 34, or a signal frequency adjusting unit 35, or any combination thereof may operate on the DSP 24.

In this embodiment, during the above-described acquisition process, the DSP 24 operates as follows. That is, the signal generating unit 32 represents one example of a signal generating unit, and generates a signal in which the satellite signal from each satellite is squared (hereinafter “signal generating function”). Furthermore, the time-frequency transforming unit 39 represents one example of a time-frequency transforming unit, and time-frequency transforms the signal thus generated (hereinafter “time-frequency transformation function”). The acquisition unit 36 represents one example of an acquisition unit, and identifies an outstanding type of frequency in the frequency characteristics acquired by time-frequency transformation, and acquires each of the satellite signals on the bases of the identified unusual frequency (hereinafter “acquisition function”). In this embodiment, a spectrum having a sharp peak is used as an example of such an “outstanding type.”

The signal frequency adjusting unit 35 represents one example of a signal frequency adjusting unit, and halves the signal frequency of the above-described frequency characteristics.

The satellite positioning device 100 stores the orbital information of the satellites in the sky at the current approximate time and location in the RAM 23, which serves as an example of a storage unit. This orbital information includes, for example, almanac and ephemeris data and the like, in the case of a GPS.

The matching unit 37 represents one example of a matching unit, and matches the estimated frequency of each satellite signal based on the above-described orbital information with the outstanding type of frequency in the above-described frequency characteristics using pattern matching or the like (hereinafter “matching function”). With such an arrangement, it is possible to identify the satellite signal of the satellite corresponding to each spectrum that appears in the frequency characteristics.

The down-converting unit 31 corresponds to one example of a downconverting unit, and decreases the frequency of the satellite signal from each satellite (or the intermediate frequency downconverted from that frequency) to a predetermined frequency (baseband) (hereinafter “downconverting function”).

The specific band passing unit 33 represents a specific band passing unit, and has a specific band passing function of passing only those frequency components of signals generated by the above-described signal generating function that are less than or equal to a predetermined frequency. The integrating unit 34 performs integration processing on time-frequency transformed signals (hereinafter “integration function”).

The satellite positioning device 100 has a configuration such as described above, and an example of the acquisition method thereof will be described below with reference to FIG. 1 to FIG. 3. One example of this acquisition method includes the reception positioning process described later. First, the “acquisition” process of a standard GPS receiver will be described.

### Background of Acquisition Process

A standard GPS receiver receives satellite signals from a plurality of satellites, and executes positioning by calculating its own position. Examples of the frequency of such a satellite signal include, for example, 1575.42 MHz. The satellite signals from the satellites are modulated by so-called BPSK. At this time, a multiplexing method referred to as code-division multiplexing (CDM) is used. This method is widely known as a modulation method capable of simultaneously transmitting a plurality of signals at the same frequency.

Specifically, codes specific to each satellite exist and the satellite signals of the respective satellites are modulated using these codes (spread spectrum). In the GPS receiver, a satellite signal cannot be demodulated (despread) unless the specific satellite code is used to apply the code at the correct timing.

On the other hand, specifically, in relation to frequency, the GPS receiver is capable of handling all satellite signals if it is capable of reception at, for example, 1575.42 MHz. However, since a plurality of satellites is orbiting the earth, each having a unique orbit, the Doppler frequency of each satellite differs for the observer (equivalent to the operator of the global positioning device 100). That is, when viewed from the GPS receiver, the satellite signals from the respective satellites slightly deviate from 1575.42 MHz. This range is known to be approximately ±5 kHz, maximum.

Furthermore, while many GPS receivers have a clock with a certain degree of accuracy due to incorporation of a crystal oscillator (TCXO), there is a limit to that accuracy and the clock may include an error of a few kHz with respect to the satellite signal. In conclusion, a general GPS receiver needs to have a mechanism that permits ±10 kHz deviation for such the value 1575.42 MHz.

During digital processing, the GPS receiver generally downconverts this 1575.42 MHz to an intermediate frequency (IF) in the pre-stage (the RF unit) since the frequency is too high. The intermediate frequency (IF) employed may be individual values according to the GPS receiver design concept. Subsequently, while the GPS receiver internally handles signals digitalized at the IF frequency, the ±10 kHz deviation from the above-described Doppler effect remains as is.

The GPS receiver generally uses a feedback loop for synchronization to a predetermined frequency and code shift. However, the GPS receiver cannot use general DLL or PLL when the correct satellite code shift and frequency deviation are not identified to a certain degree as described above. Thus, in the GPS module, an “acquisition” stage is generally provided in the pre-stage of loop-based signal tracking. While calculations are performed to roughly identify the frequency deviation in this embodiment, calculations for roughly identifying the cost shift as described later may also be performed.

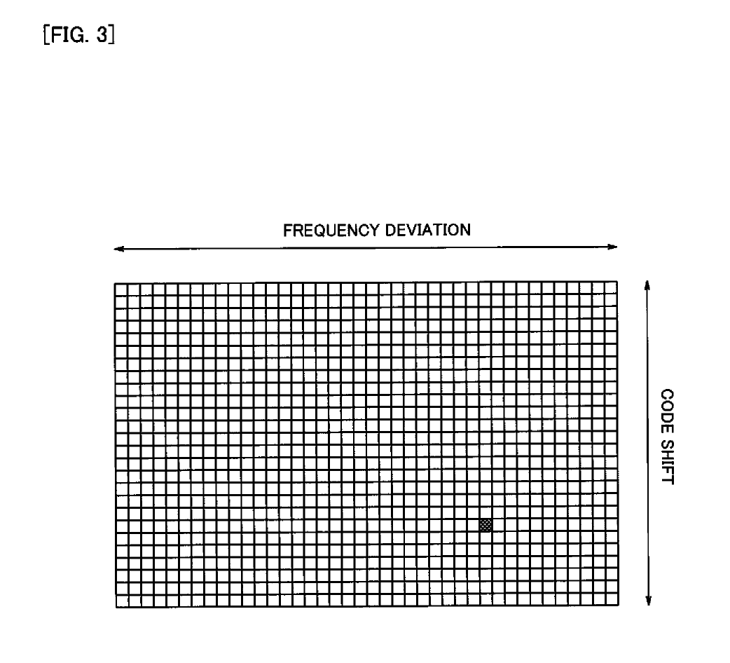

FIG. 3 is an image of an acquisition field for the acquisition process. The horizontal axis indicates the frequency deviation due to the Doppler effect associated with satellite movement, and the vertical axis indicates the above-described code shift.

In this acquisition process, the acquisition field appears as a two-dimensional search field as shown in the figure. That is, this acquisition field is a concept designed to identify the square (referred to as “bin”) in which the desired satellite signal exists within the wide field while testing each bin one by one. The acquisition field shows a field of bins related to frequency (called “frequency bins”). While various methods have been proposed as the signal processing method of the acquisition process, deviation of the temperature compensated crystal oscillator (equivalent to the so-called TCXO) and the like vary according to temperature and solid matter, and an effective conventional method does not exist.

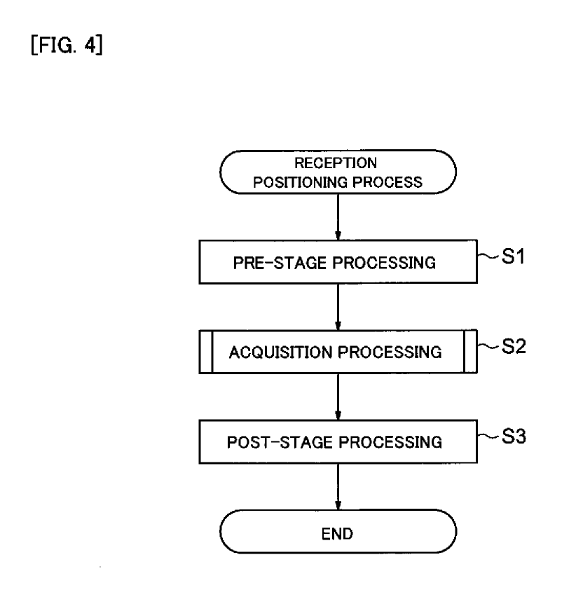

FIG. 4 is a flowchart illustrating an example of the procedure of the reception positioning process. This reception positioning process includes pre-stage processing (step S1), acquisition processing (step S2), and post-stage processing (step S3).

In step S1, the RF unit 1 executes pre-stage processing. In this pre-stage processing, when the GPS antenna 10 receives a satellite signal from a satellite, that satellite signal is inputted to the BPF 12 via the RF input unit 11. The BPF 12 passes and outputs only those satellite signals in a predetermined bandwidth to the LNA 14. The LNA 14 functions as a low noise amplifier, and outputs the satellite signals thus passed within that predetermined bandwidth to the BPF 14. Satellite signal noise that is outside the GPS bandwidth is attenuated via the BPF 14 and inputted to the downconverter 15.

The TCXO 17 is a local oscillator that oscillates frequencies lower than the frequency of the received signal inputted to the downconverter 15. The frequency synthesizer 18 generates a local oscillator signal based on the output from the TCXO 17, and outputs the generated signal to the downconverter 15. The downconverter 15 uses the local oscillator signal from the frequency synthesizer 18 and converts the RF signal, which is the received signal, to an IF (Intermediate Frequency) signal according to the control performed by the AGC 16.

The converted IF signal is converted from an analog signal to a digital signal in the A/D converting unit 19, and then outputted to the digital processing unit 2. Furthermore, that the TCXO 17 is used for calculating the pseudo range between the satellite and GPS antenna 10. The TCXO 17, unlike an atomic clock mounted on a satellite, includes errors. As described above, the “error of the built-in clock of the satellite positioning device” refers to the error of the TCXO 17.

Subsequently, in step S2, the digital processing unit 2 executes the acquisition process. In this acquisition process, the digital processing unit 2 executes the acquisition processing described later based on the IF signal. Subsequently, in step S3, the digital processing unit 2 executes the tracking process and the positioning process.

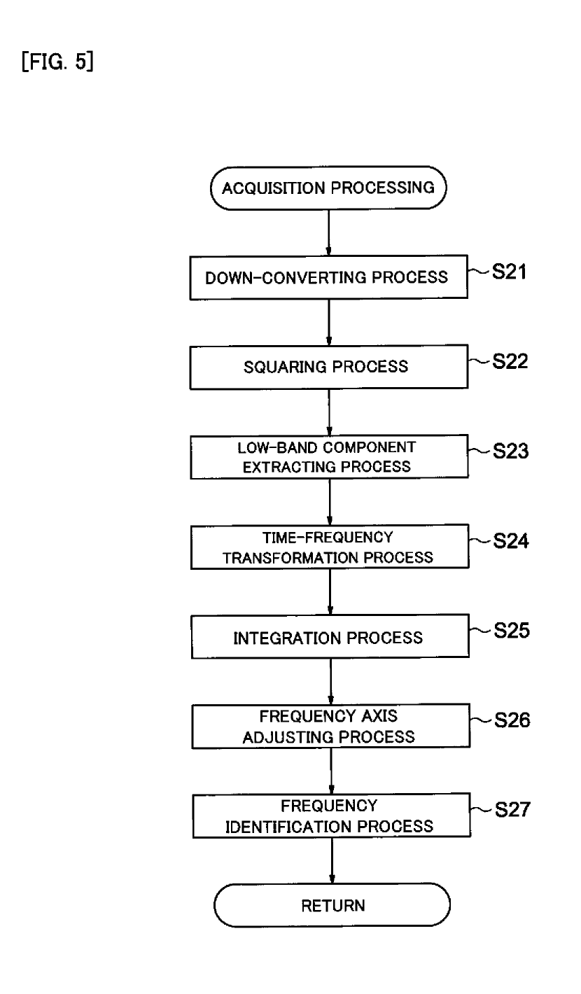

FIG. 5 is a flowchart illustrating an example of the procedure of the acquisition process shown in FIG. 4.

First, in step S21, the DSP 24 corresponding to the downconverting unit downconverts the IF signal to a predetermined frequency (baseband) according to the control performed by the CPU 20. While this downconverting process may be omitted, when it is executed in this manner, the amount of calculation decreases in an amount corresponding to the decrease in frequency. Additionally, when such a downconverting process is executed and the satellite signal from each satellite is squared by the signal generating function, it is possible to avoid the appearance of a direct current component (DC component) in the signal generated by the squaring process.

Subsequently, in step S22, the signal generating unit 32 squares the signal thus downconverted according to the control performed by the CPU 20. The signal downconverted here is expressed by a phase-modulated sine wave, for example, and is converted to a cosine wave having twice the frequency by the squaring process. Here, satellite signals of a different satellite that coexist within the same signal differ in spreading code. Therefore, when the signal generating unit 24 squares the satellite signal, the sine waves are accurately multiplied without despreading. As a result, the sum term and the difference term of the two waves do not appear as an outstanding type in frequency characteristics. An outstanding type refers to a spectrum having a sharp peak, for example.

Thus, the above-described process results in only the frequency equivalent to twice the frequency at which the satellite signal from the satellite exists appearing with a sharp peak in the spectrum. In this satellite positioning device 100, even in a case where the Doppler frequency of the satellite signal from each satellite deviates from the actual center frequency, it is possible to hit to a certain degree the vital spot of the frequency at which the satellite signals will arrive, and extract only that frequency information.

Subsequently, in step S23, the specific band passing unit 33 passes only the above-described signal frequency components having a predetermined frequency or less.

Subsequently, in step S24, the time-frequency transforming unit 39 uses Fast Fourier Transform (FFT), for example, to execute time-frequency transformation on the extracted signals and acquire frequency characteristics expressed by amplitude with respect to frequency, for example.

The time-frequency transforming unit 39 is not limited to such the FFT, but may use any other type of time-frequency transformation as long as the type is capable of expressing the fluctuating state of amplitude with respect to frequency for certain signals.

When the time-frequency transforming unit 39 thus executes the time-frequency transformation process, the frequency characteristics resulting from this process feature a sharp spectrum rise at a frequency equivalent to twice that of the frequency where the satellite signals exist. This makes it possible to identify the corresponding frequencies and satellites of the satellite signals in the frequency characteristics. Furthermore, in this embodiment, when the satellite number is identified and the code chip shift is found as described later, it possible to significantly reduce the time required for acquisition.

Such a time-frequency transformation process has advantages such as the following. First, consider a case where the width of one frequency bin is 100 Hz and an attempt is made to cover a frequency deviation equivalent to ±10 kHz, for example. Then, for this frequency bin, 200 bins exist. According to such a time-frequency transformation process, it is possible to hit the vital spot of the frequency where each of the satellite signals exist in a single process without searching each bin of the above-described FIG. 3 one by one, thereby enabling reduction of the processing time of the acquisition stage (acquisition process: equivalent to step S2) by about 200 times, maximum.

In the next step S25, the integrating unit 34 executes an integration process on the signal generated by the time-frequency transformation function of the above-described time-frequency transforming unit 39. While this integration process may be omitted, when such an integration process is executed, a spectrum that rises because a satellite signal from a satellite exists in the aforementioned frequency characteristics exhibits an even sharper rise, making it easier to detect the sharp peak.

Subsequently, in step S26, the acquisition unit 36 executes a frequency axis adjustment process on such frequency characteristics. In this frequency axis adjustment process, the signal frequency adjusting unit 35 halves the signal frequency of the frequency characteristics, for example. The reason the signal frequency of frequency characteristics is halved is to adjust the signal frequency since the signal frequency was doubled by the above-described squaring processing.

Subsequently, in step S27, the acquisition unit 36 executes a frequency identification process. In this frequency identification process, the acquisition unit 36 identifies the frequency as follows, even if frequency deviation occurs in the frequency of the satellite signal due to the Doppler effect associated with satellite movement (that is, even if the frequency has become a Doppler frequency).

That is, this acquisition unit 36 hits the vital spot based on the spectrum that sharply rises in the above-described frequency characteristics, according to the control performed by the CPU 20, making it possible to identify the frequency at which the sharp spectrum is established (Doppler frequency: includes TCXO shift).

When such a frequency identification process is performed, it is possible to quickly identify the frequency of the satellite signals at which the sharp spectrum is obtained, that is, the satellite number, thereby enabling the acquisition unit 36 to perform the overall acquisition process about 1000 times faster than the conventional process.

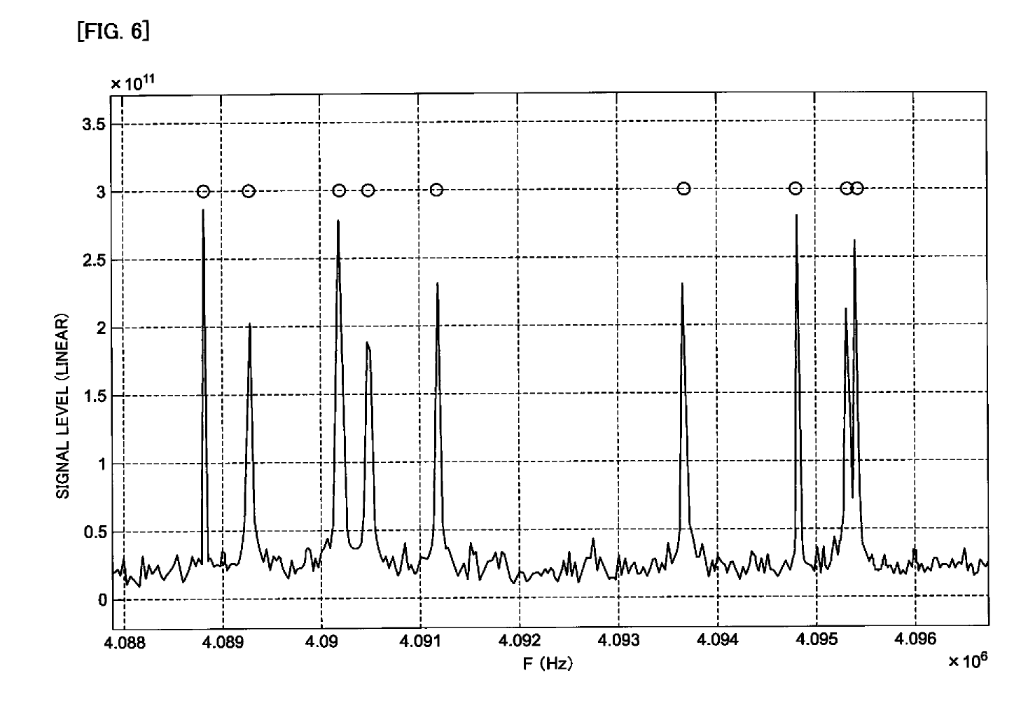

FIG. 6 is a diagram illustrating an example of the peaks that appear at the frequencies corresponding to each satellite signal in the frequency characteristics obtained by the acquisition process shown in FIG. 5. In FIG. 6, the vertical axis indicates the strength of the signal level of the satellite signal, and the horizontal axis indicates frequency F[Hz].

In the above-described time-frequency transformation process, the satellite signals obtained by the squaring process as described above are established as characteristics indicating the signal levels corresponding to such frequencies, for example. In this FIG. 6, the center frequency of the Doppler frequencies that produce frequency deviation is illustrated as 4.092 [×10⁶ Hz], for example, and frequency deviation is shown to occur in each satellite signal by the Doppler effect associated with the movement of each satellite.

Referring to this frequency characteristics example, it appears that spectrums having nine sharp peaks exist, for example. The frequencies of the spectrums having these sharp peaks respectively indicate the Doppler frequencies of a plurality of satellite signals from a plurality of satellites (and include TCXO shift as well). As such, although the respective satellites corresponding to the satellite signals of each of these spectrums having a sharp peak is not known, it is possible to hit the vital spot of the Doppler frequency of each satellite signal from each satellite without conducting a point by point search for each one of the satellite signals. Furthermore, in FIG. 6, a row of open circles appears at the frequency location where a vital spot is hit, that is, at a signal level of 3×10¹¹, for example.

The acquisition unit 36 is capable of identifying the satellites of the satellite signals corresponding to each sharp peak in the frequency characteristics as described below, if orbital information is provided in advance in the RAM 23. The term “orbital information” used here refers to at least almanac or ephemeris data, if not both.

When such the acquisition unit 36 starts the reception positioning process in a state where orbital information is provided in advance, the start is referred to a “warm start” or a “hot start.” On the other hand, when the acquisition unit 36 starts the reception positioning process without having such orbital information, the start is referred to as a “cold start.”

Specifically, the matching unit 37 specifies the satellites of the satellite signals corresponding to the sharp spectrums that appear in frequency characteristics by pattern matching, for example, based on the aforementioned orbital information of each satellite.

Specifically, when the start is a hot start with orbital information provided as prior information, the matching unit 37 is capable of identifying the position of each satellite in air space of a certain location at a specific time, making it possible to estimate the Doppler frequency of the satellite signal from each satellite with a certain degree of accuracy.

Here, the TCXO 17 built into the satellite positioning device 100 generally has a slight amount of frequency deviation, and the level of this frequency deviation is expressed as a function of temperature and the like. As a result, without knowing the correct amount of frequency deviation at the present moment, it seems impossible to estimate the correct bin of the acquisition field shown in FIG. 3 at a glance.

Nevertheless, in this embodiment, the matching unit 37 is capable of estimating the Doppler frequency of the satellite signal from each satellite using the above-described orbital information, and clearly identifying the frequency at which each satellite signal exists in the frequency characteristics.

Specifically, the matching unit 37 matches each frequency of the peaks in the above-described frequency characteristics with the frequency of each satellite signal calculated from the orbital information by pattern matching or the like. With this arrangement, the matching unit 37 is capable of clearly defining the frequencies of the satellite signals to be acquired by the acquisition unit 36.

The satellite positioning device 100 of the above embodiment comprises the signal generation unit 32 (equivalent to the signal generating unit) that generates a signal in which the satellite signal from each satellite is squared, the time-frequency transforming unit 39 (equivalent to the time-frequency transforming unit) that time-frequency transforms the signal generated by the signal generating unit, and the acquisition unit 36 (equivalent to the acquisition unit) that identifies the frequency of an outstanding type in the frequency characteristics obtained by time-frequency transformation by the time-frequency transforming unit 39 and acquires each of the satellite signals based on the identified frequency.

The acquisition method of the above embodiment comprises the steps of a signal generating step for generating a signal in which the satellite signal of each satellite is squared, a time-frequency transforming step for time-frequency transforming the signal generated by the signal generating step, and an acquisition step for identifying the frequency of an outstanding type in the frequency characteristics based on the signal generated by the time-frequency transforming step and acquiring each of the satellite signals based on the identified frequency.

First, in this embodiment, the squaring of the satellite signals from the plurality of satellites makes it possible to obtain an effect similar to despreading with the satellite signal itself. That is, squaring a satellite signal has the same implications as despreading the correct code at the correct timing using the correct frequency.

Specifically, squaring the satellite signals from the plurality of satellites creates, for a sine wave of a certain frequency, a frequency signal of twice the frequency, by a sine wave squaring formula. That is, a sine wave that includes an arbitrary Doppler frequency of each satellite is converted to a cosine wave of a frequency equivalent to twice the frequency by the squaring process.

Then, when the signal expressed by this cosine wave is subjected to time-frequency transformation, the frequency characteristics related to the signal are obtained. Here, since satellite signals of different satellites that coexist within the same satellite signal differ in spreading code, squaring the satellite signals in this manner accurately multiplies the sine waves without despreading. As a result, the sum term and the difference term of the two waves do not appear as an outstanding type in the frequency characteristics. This outstanding type refers to a spectrum having a sharp peak, for example.

Thus, the above-described process results in only the specific frequency where the satellite signal from the satellite exists appearing as a sharp peak in the spectrum. With this satellite positioning device 100 and this acquisition method, even in a case where the Doppler frequency of the satellite signal from each satellite is spread away from the actual center frequency, the vital spot indicating the frequency at which the satellite signals will arrive is hit to a certain degree, making it possible to extract just the frequency information, identify the Doppler frequency of the satellite signal from each satellite based on this frequency information, and acquire each satellite.

Normally, in the time-frequency transformation (FFT) of signal processing dealing with satellite signals, for example, such a squaring process cannot be simply handled since the satellite code contains 1023 chips, for example.

Further, the Doppler effect not only affects the above-described frequency, but also the code itself of each satellite. Even though the effect on the code is slight, it impacts the integration process over the long term. Nevertheless, in the satellite positioning device 100, despreading is performed using the received satellite signal itself and not the code of each satellite produced within the receiver, eliminating the above-described inhibitory element. Additionally, in the satellite positioning device 100, phase modulation by the navigation message of each satellite at despreading is also negated, making it possible to apply long-term time-frequency transformation (FFT) after squaring.

The satellite positioning device 100 of the above embodiment, in addition to the above-described configuration, further comprises the signal frequency adjusting unit 35 (equivalent to the signal frequency adjusting unit) that halves the signal frequency in the frequency characteristics.

The satellite positioning device 100 of the above embodiment, in addition to the above-described configuration, further comprises the down-converting unit 31 (equivalent to the down-converting unit) that decreases the frequency of the satellite signal from each satellite to a predetermined frequency (equivalent to the baseband).

With this arrangement, when the signal generating unit squares the satellite signal from each satellite, it is possible to avoid the appearance of direct current components (DC components) of the squared signal and reduce the amount of calculations by an amount corresponding to the decrease in frequency.

The satellite positioning device 100 of the above embodiment, in addition to the above-described configuration, further comprises the specific band passing unit 33 (equivalent to the specific band passing unit) that passes only frequency components having a frequency less than or equal to a predetermined frequency, the frequency components being included in the signal generated by the signal generating unit.

With this arrangement, it is possible to remove the spurious characteristics of the signal generated by the signal generating unit 24.

The satellite positioning device 100 of the above embodiment, in addition to the above-described configuration, further comprises the integrating unit 34 (equivalent to the integrating unit) that executes integration processing on the signal generated by the time-frequency transforming unit 39.

While normally it is difficult to detect signals from satellites in frequency characteristics since the signals are buried in noise, such an integration process causes a sharp spectrum to appear from within the noise, making it possible to easily detect the frequency based on this spectrum.

The satellite positioning device 100 of the above embodiment, in addition to the above-described configuration, further comprises the temperature compensated crystal oscillator 17 (equivalent to the TCXO) that generates a reference clock as it performs temperature compensation when the satellite signal from each of the satellites is converted to an intermediate frequency, the storage unit 23 that stores the orbital information of each satellite, and the matching unit 24 that matches the frequency indicating an outstanding type in the frequency characteristics with the estimated frequency of each of the satellite signals based on the orbital information.

With this arrangement, based on the orbital information, the matching unit 24 is capable of easily identifying the satellite of the satellite signal on which each spectrum having a sharp peak in frequency characteristics is based. In addition, based on the movement direction and movement velocity of each satellite identifiable based on the orbital information, the matching unit 24 is capable of accurately estimating the Doppler frequency of the satellite signal arriving from each satellite. As a result, based on the difference between the estimated Doppler frequency and the frequency based on the satellite signal from the satellite identified from the above-described orbital information, the matching unit 24 can identify the frequency deviation of the temperature compensated crystal oscillator (corresponding to the TCXO) built into the satellite positioning device 100 for each satellite.

### Identifying the Angle of Elevation of a Satellite

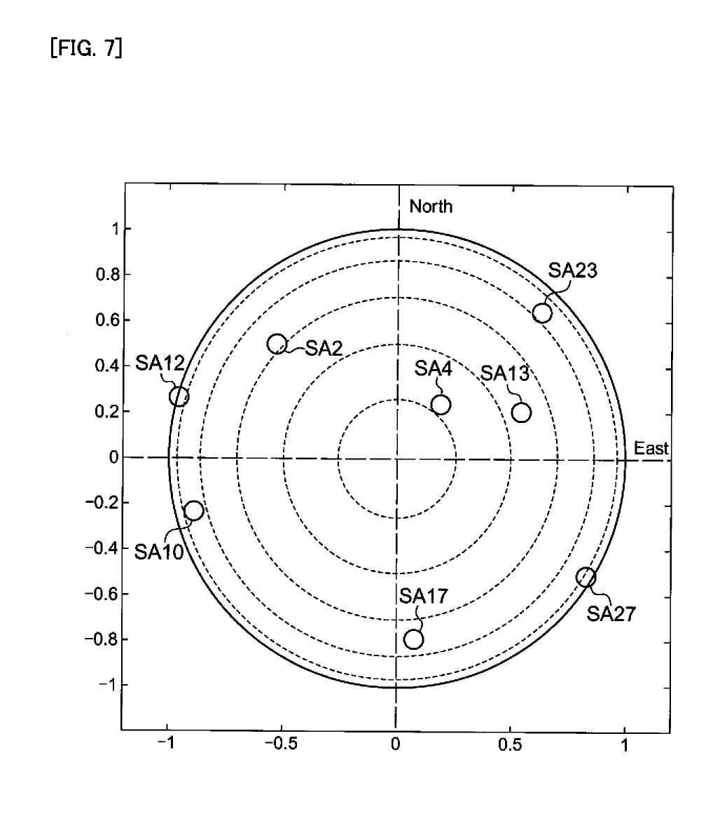

FIG. 7 is a diagram illustrating an example of the position in the sky of each satellite at a certain time, obtained from almanac data (orbital information). Note that in the diagram the outermost circle indicates the air space below the horizon, and the center section indicates the sky. From the outermost circle to the center, a circular reference line indicating the elevation angle is provided at every elevation angle of 15°. In FIG. 7, the upward direction is north, the downward direction is south, the rightward direction is east, and the leftward direction is west.

According to the sky distribution diagram of each satellite, each satellite respectively corresponding to satellite numbers 2 (corresponding to code SA2, 4 (corresponding to code SA4), 10 (corresponding to code SA10), 12 (corresponding to code SA12), 13 (corresponding to code SA13, 17 (corresponding to code SA17), 23 (corresponding to code SA23), and 27 (corresponding to code SA27) appear to be in the sky at a certain specific time.

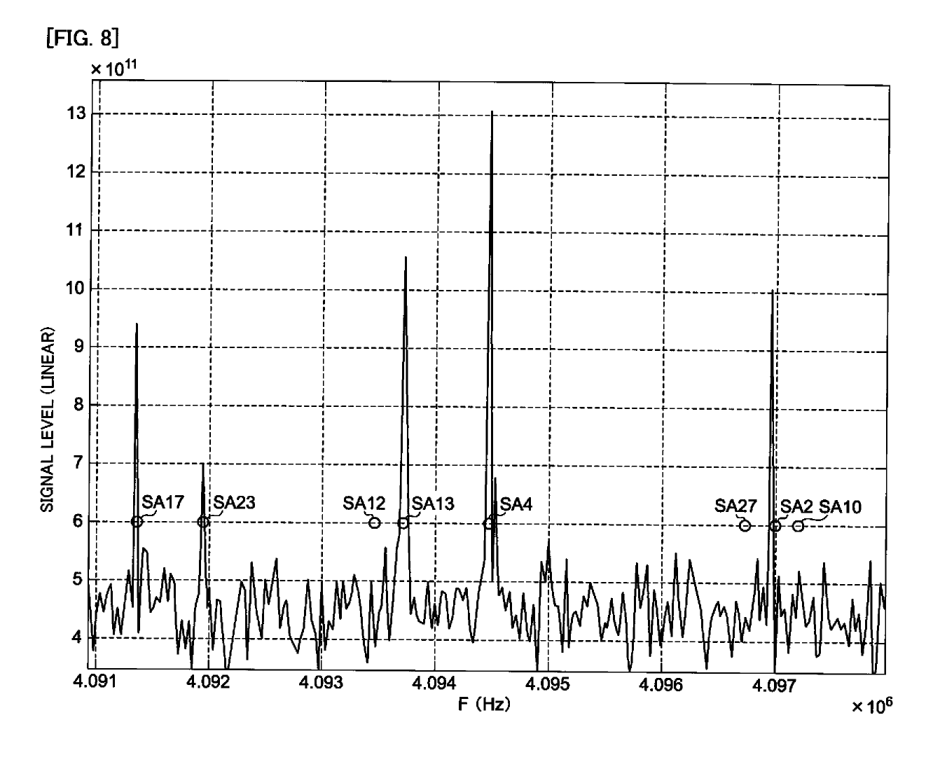

FIG. 8 is a diagram illustrating an example of frequency characteristics at that specific time. Note that the frequency characteristics shown in FIG. 8 correspond to each satellite shown in FIG. 7.

In FIG. 7, the satellites at or below an elevation angle of 20° do not have a spectrum showing a sharp peak in FIG. 8. Such satellites having a low elevation angle are illustrated as the satellite having satellite number SA12, the satellite having satellite number SA10, and the satellite having satellite number SA27, as viewed from the left in the frequency characteristics.

On the other hand, satellites having an elevation angle of about 20° or higher have spectrums that show a sharp peak. Such satellites having an elevation angle that is not low are illustrated as the satellite having satellite number SA17, the satellite having satellite number SA23, the satellite having satellite number SA13, the satellite having satellite number SA4, and the satellite having satellite number SA2, as viewed from the left in the frequency characteristics.

As is understood with reference to the frequency characteristics shown in FIG. 8, spectrums having a level of strength (a sharper peak) to the extent of the satellite signal from the satellite having satellite number SA4, which has a high elevation angle, appear. Thus, it is possible to obtain the elevation angle of each satellite at a certain specific time in accordance with such levels of strength.

The satellite positioning device 100 of the above embodiment, in addition to the above-described configuration, further comprises the elevation angle identifying unit (equivalent to the elevation angle identifying unit) that identifies the elevation angle of each of the satellites in accordance with the strength of the outstanding type in the frequency characteristics.

With such an arrangement, the acquisition unit 36 can roughly identify the elevation angle of each satellite, facilitating subsequent tracking.

Note that the embodiments of the present invention are not limited to the above, and various modifications are possible. In the following, details of such modifications will be described one by one.

While a GPS system was used as an illustrative example of the satellite positioning system in the above embodiment, the present invention is not limited thereto, allowing application to other satellite positioning systems such as Galileo or QZSS (Quasi Zenith Satellite System), for example.

Further, the satellite positioning system of the above embodiment may perform the processing such as the following in place of a squaring process such as described in the above embodiment.

First, in a satellite positioning system such as a GPS, it is known that the unique code (spreading code) has a length of 1 msec. As a result, all satellites specifically send a repeated signal every 1 msec. Furthermore, the navigation message included in the radio waves from a satellite is repeatedly sent at an interval of 20 msec.

Thus, if the navigation message section is ignored, for example, despreading can be performed by multiplication in the same manner as the above embodiment, even with a satellite signal having a time delay of n times (where n is a natural number) of 1 msec. According to such a method, while performance slightly deteriorates compared to the above-described embodiment since the navigation message effect remains and multiplication is performed without taking into consideration the impact of the Doppler effect on each code, the method exhibits substantially the same advantages as the above-described embodiment.

1-8. (canceled)

9. A satellite positioning device comprising:
signal generating means configured to generate a signal in which a satellite signal from each satellite is squared;
time-frequency transforming means configured to execute time-frequency transformation on the signal generated by said signal generating means; and
acquisition means configured to identify a frequency of an outstanding type in frequency characteristics acquired by time-frequency transformation by said time-frequency transforming means, and acquire each of the satellite signal based on said identified frequency.

10. The satellite positioning device according to claim 9, further comprising signal frequency adjusting means configured to halve a signal frequency in said frequency characteristics.

11. The satellite positioning device according to claim 9, further comprising down-converting means configured to decrease the frequency of the satellite signal from each of said satellites to a predetermined frequency.

12. The satellite positioning device according to claim 9, further comprising specific band passing means configured to pass only frequency components having a frequency less than or equal to a predetermined frequency, said frequency components being included in the signal generated by said signal generating means.

13. The satellite positioning device according to claim 9, further comprising integrating means configured to perform integration processing on the signal generated by said time-frequency transforming means.

14. The satellite positioning device according to claim 9, further comprising:
a temperature compensated crystal oscillator configured to generate a reference clock while performing temperature compensation when a satellite signal from each of the satellites is converted to an intermediate frequency;
storage means configured to store orbital information of each of the satellites; and
matching means configured to match the frequency indicating the outstanding type in said frequency characteristics with an estimated frequency of each of the satellite signals based on said orbital information.

15. The satellite positioning device according to claim 9, further comprising elevation angle identifying means configured to identify an elevation angle of each of the satellites in accordance with strength of the outstanding type in said frequency characteristics.

16. An acquisition method comprising the steps of:
a signal generating step for generating a signal in which a satellite signal from each satellite is squared;
a time-frequency transforming step for executing time-frequency transformation on the signal generated by said signal generating step; and
an acquisition step for identifying a frequency of an outstanding type in frequency characteristics based on the signal generated by said time-frequency transforming step, and acquiring each of the satellite signals based on said identified frequency.

17. The satellite positioning device according to claim 10, further comprising:
a temperature compensated crystal oscillator configured to generate a reference clock while performing temperature compensation when a satellite signal from each of the satellites is converted to an intermediate frequency;
storage means configured to store orbital information of each of the satellites; and
matching means configured to match the frequency indicating the outstanding type in said frequency characteristics with an estimated frequency of each of the satellite signals based on said orbital information.

18. The satellite positioning device according to claim 11, further comprising:
a temperature compensated crystal oscillator configured to generate a reference clock while performing temperature compensation when a satellite signal from each of the satellites is converted to an intermediate frequency;
storage means configured to store orbital information of each of the satellites; and
matching means configured to match the frequency indicating the outstanding type in said frequency characteristics with an estimated frequency of each of the satellite signals based on said orbital information.

19. The satellite positioning device according to claim 12, further comprising:
a temperature compensated crystal oscillator configured to generate a reference clock while performing temperature compensation when a satellite signal from each of the satellites is converted to an intermediate frequency;
storage means configured to store orbital information of each of the satellites; and
matching means configured to match the frequency indicating the outstanding type in said frequency characteristics with an estimated frequency of each of the satellite signals based on said orbital information.

20. The satellite positioning device according to claim 13, further comprising:
a temperature compensated crystal oscillator configured to generate a reference clock while performing temperature compensation when a satellite signal from each of the satellites is converted to an intermediate frequency;
storage means configured to store orbital information of each of the satellites; and
matching means configured to match the frequency indicating the outstanding type in said frequency characteristics with an estimated frequency of each of the satellite signals based on said orbital information.

21. The satellite positioning device according to claim 10, further comprising elevation angle identifying means configured to identify an elevation angle of each of the satellites in accordance with strength of the outstanding type in said frequency characteristics.

22. The satellite positioning device according to claim 11, further comprising elevation angle identifying means configured to identify an elevation angle of each of the satellites in accordance with strength of the outstanding type in said frequency characteristics.

23. The satellite positioning device according to claim 12, further comprising elevation angle identifying means configured to identify an elevation angle of each of the satellites in accordance with strength of the outstanding type in said frequency characteristics.

24. The satellite positioning device according to claim 13, further comprising elevation angle identifying means configured to identify an elevation angle of each of the satellites in accordance with strength of the outstanding type in said frequency characteristics.
